(19) United States
(12) Patent Application Publication
(10) Pub. No.: US 2020/0260653 A1
(43) Pub. Date: Aug. 20, 2020

(54) Artificial intelligence driven horticulture system

(71) Applicants: Pamela Kathleen Douglas, Winter Park, FL (US); Robert Edwin Douglas, Winter Park, FL (US)

(72) Inventors: Pamela Kathleen Douglas, Winter Park, FL (US); Robert Edwin Douglas, Winter Park, FL (US)

(21) Appl. No.: 16/748,208

(22) Filed: Jan. 21, 2020

Related U.S. Application Data
(60) Provisional application No. 62/794,867, filed on Jan. 21, 2019.

(51) Int. Cl. A01G 7/04; A01G 27/00; A01G 7/02; G06N 3/08; G06N 7/00

(52) U.S. Cl. CPC A01G 7/045; A01G 27/003; G06N 7/00; G06N 3/08; A01G 7/02

(57) ABSTRACT

This patent provides a method, apparatus and software for an integrated, automated, and largely hands-free gardening in a constrained space. It consists of vertical and horizontal placement of a system-of-systems consisting of: a control element; light sources, removable garden modules, vertical rotating pillars, and fluid reservoir, which may be configured for aquaponics and includes plumbing for distribution and re-cycling of fluids.

### CROSS REFERENCE TO RELATED APPLICATIONS

The present application claims the benefit of U.S. Provisional Application 62/794,867 filed on Jan. 21, 2019.

### TECHNICAL FIELD

Aspects of this disclosure are generally related to horticulture.

### BACKGROUND

Heart disease represents the most common cause of morbidity and mortality in the United states amongst both men and women. Several conditions and lifestyle choices put people at greater risk for heart disease including obesity, diabetes, and poor diet (CDS, NCHS 2015). Although a healthy diet is essential for reducing cardiovascular disease, diabetes, and certain cancers, meta-analyses have demonstrated that the cost of healthy dietary options is significantly higher than their less expensive, unhealthy counterparts (Rao et al. 2013). This is particularly important for socioeconomically disadvantaged groups that have the highest rates of obesity and cardiovascular events, and are less likely to eat a healthy diet, due in part, to the cost prohibitive nature of purchasing healthy options (Banks et al. 2006; Darmon et al. 2008).

Although growing healthy food may alleviate certain financial pressures of eating healthy, many families and individuals lack the time and space required for such practices. Recently, advances in artificial intelligence have enabled dramatic breakthroughs in computer vision and object recognition that even outperform human capabilities on certain tasks. Deep learning algorithms, in particular, have become the workhorse of modern artificial intelligence systems.

Deep learning algorithms discover intricate structure in data or images by passing representational patterns through multiple layers in a network (LeCun et al. 2015).

### SUMMARY

All examples, aspects and features mentioned in this document can be combined in any technically possible way.

The goal of this novel method and apparatus is to reduce financial barriers to eating healthy via the creation of an automated closed-loop device for horticulture with parameters (e.g., lighting schedule, watering, ventilation) that are optimized via artificial intelligence (e.g., deep learning algorithms). Reinforced learning would be applied to leverage big data and update horticulture control parameters on a continual basis.

All examples, aspects and features mentioned in this document can be combined in any technically possible way.

This patent provides a method, apparatus and software for an integrated, automated, and largely hands-free gardening system in a constrained space. It consists of vertical and horizontal placement of a system-of-systems consisting of: a control element; light sources, removable garden modules, vertical rotating pillars, and fluid reservoir, which may be configured for aquaponics and includes plumbing for distribution and re-cycling of fluids. Multiple lighting systems that may be placed above, below, to the sides, or within unit modules (e.g., decorative lighting within the aquaponics module). A series of garden modules or shelves, which can be moved without disrupting other modules in the system. A motorized module with rotating pillars that may be hollow with perforations or contain fasteners to permit plants to adhere to and rotate gradually as they grow. The system may also contain sensors for measuring growth, chemical concentrations, water levels, pH, temperature, humidity, and other atmospheric sensors. The system may be powered via electric, solar, or via internally induced energy from photosynthesis and/or bacteria. The system may also incorporate hardware and software to adjust controls for lighting schedules including intensity and frequency, watering parameters, and rotation dynamics, ventilation adjustments, and wife capabilities to enable interoperability with the internet of things, and/or with software, application or hardware that may be enabled with artificial intelligence capabilities to adjust these parameters. The system may also have cameras above, below or within each module that may capture images traditional photos from the visual light spectrum, or within other ranges of the electromagnetic spectrum (e.g., infrared). These images may also be used for interoperability with the internet of things, as well as used as inputs into software, applications, or hardware that may be capable of adjusting system parameters (e.g., lighting schedules).

Users may adjust system parameters manually. However, all sensor information may also be used in a closed-loop fashion, where software and/or hardware implementations may optimize system parameters. The goal of some implementations may optimization of crop yield, quality, or taste. Some implementations comprise but, are not limited to, an apparatus consisting of a system-of-systems to enable automated growth of fruits and vegetables is a constrained space. There are several key elements First, a rigid enclosed structure with one or more of the following: doors with windows to enable access to the contents and viewing thereof; moveable shelving and/or bins on which to place growing plants; rotatable vertical poles to support vine type plants. A water reservoir (tank) to hold water with nutrients to support hydroponic, aquaponic and/or traditional watering with one or more of the following sub-systems or components: a water pump to distribute the water; a filtration system to treat water; a sensor system to measure water pH; an air pump to aerate the water; a temperature gage to measure water temperature and associated heating/cooling apparatus to maintain desired temperature levels; an automated sub-system to periodically replenish nutrients in the water; an automated water level monitoring sub-system to plumbing to distribute the water; A lighting subsystem. Examples include but, are not limited to: high intensity discharge which may utilize high pressure sodium or metal halide; T5 high output fluorescent; LED light of different frequencies a timing system to turn on/off lights at specified times. An environmental control system consisting of one or more of the following: humidity control sub-system with the following options: humidity sensor system; humidifiers and/or dehumidifiers; temperature control sub-system the following options: temperature monitoring and control element; heating and cooling element. a CO2 monitoring sub-system and associated CO2 container to increase CO2 levels upon command; and/or other environmental sensors for ventilation, pressure, and/or nutrient content. A hydroponic/aquaponic component consisting of one or more of, but not limited to, the following: nutrient film technique sub-system to distribute water with nutrients; a dripping sub-system to distribute water with nutrients; a misting sub-system to distribute water with nutrients; a medium consisting of perlite, chopped rockwool, etc. plumbing within the rigid structure to support distribution of water with nutrients in accordance with the installed distribution sub-system. A master control element to monitor and effect changes in lighting, environmental control, hydroponic/aquaponic system-of-systems operations consisting of the following: a control panel with capability to set environment operational limits, lighting timing a computing element; wireless connection to internet router; software to monitor and operate the system-of-systems with capabilities including but, not limited to the following: recording the status and conditions of lighting, environmental control, hydroponic/aquaponic system-of-systems; planting and expected harvesting dates of fruits and vegetables; interacting with commands and requests for information with the internet of things. Electrical wiring to all electrical components; A container(s) to hold earth: medium consisting of perlite; vermiculite; chopped rockwool; etc. Some implementations comprise but, are not limited to, the rigid structure may optionally include windows in one or more of the sides of each module, to provide access to the interior of each module without having to disassemble the module. The modules may include a control panel and other features enabling control of one or more aspects of the system. Some implementations comprise but, are not limited to, a series of gardening and/or hydroponic shelves of varying height. The drawer system enables each module to slide out for easy access to the garden unit. An example embodiment would be a drawer system with wheels, or slits on the inner side panel of the apparatus. Each module may slide in or out and be removed without disturbing the remainder of the gardening units or components of the watering system. Some implementations comprise but, are not limited to, a lighting system which may be above, below, to the sides, within modules. Lighting units may contain lights of different frequencies altered via a controller. Lighting units may also be fixed to garden shelving modules.

Some embodiments comprise wherein weather pattern data from regions of the Earth are profiled. For example, profile the wire region of France. Then, input the parameters (e.g., humidity, daylight hours, rain, temperature, frequency of light, wind, etc.) into the horticulture system to cause the crop yield to match that of the wine region of France.

Some embodiments comprising wherein the artificial intelligence system analyzes data from an artificial gravity device to maximize plant growth in micro-gravity environments. For example, the apparatus could be placed into a simulated gravity device, such as is described in U.S. patent application Ser. No. 15/679,329, Simulated Gravity Device. See FIG. 1B. A variety of gravitational fields could be utilized to determine which gravitational field yields the highest productivity.

Definition: A confined area, as used in this patent application, refers relatively small area such as a kitchen or porch which could accommodate the horticultural structure which could nominally be the size of a double wide refrigerator.

### BRIEF DESCRIPTION OF THE FIGURES

The patent or application file contains at least one drawing executed in color. Copies of this patent or patent application publication with color drawing(s) will be provided by the Office upon request and payment of the necessary fee.

FIG. 1 illustrates a process for automated horticulture in confined areas.

FIG. 2 illustrates a system illustration and description.

FIG. 3A illustrates varying sizes and configurations of the apparatus.

FIG. 3B illustrates an example wireless phone can interact with the horticultural system.

FIG. 4 example configuration with door open and plant tray protruding from structure for easy access by user.

FIG. 5 illustrates an example water delivery system components.

FIG. 6A illustrates a first example lighting system layout.

FIG. 6B shows a circular arrangement of lights at a first time point.

FIG. 6C shows a circular arrangement of lights at a second time point.

FIG. 7A illustrates a first example rotatable pole mounting configuration.

FIG. 7B illustrates a second example rotatable pole mounting configuration.

FIG. 8A illustrates a rotatable pole with textures.

FIG. 8B illustrates small spikes or hooks which protrude from the outer surface of the pole.

FIG. 8C illustrates a textures groove surface on the outside portion of the pole.

FIG. 9 illustrates bringing in artificial intelligence to optimize plant growth.

FIG. 10 illustrates an example interface with the internet of things.

### DETAILED DESCRIPTION OF FIGURES

Some aspects, features and implementations described herein may include machines such as computers, electronic components, radiological components, optical components, and processes such as computer-implemented steps. It will be apparent to those of ordinary skill in the art that the computer-implemented steps may be stored as computer-executable instructions on a non-transitory computer-readable medium. Furthermore, it will be understood by those of ordinary skill in the art that the computer-executable instructions may be executed on a variety of tangible processor devices. For ease of exposition, not every step, device or component that may be part of a computer or data storage system is described herein. Those of ordinary skill in the art will recognize such steps, devices and components in view of the teachings of the present disclosure and the knowledge generally available to those of ordinary skill in the art. The corresponding machines and processes are therefore enabled and within the scope of the disclosure.

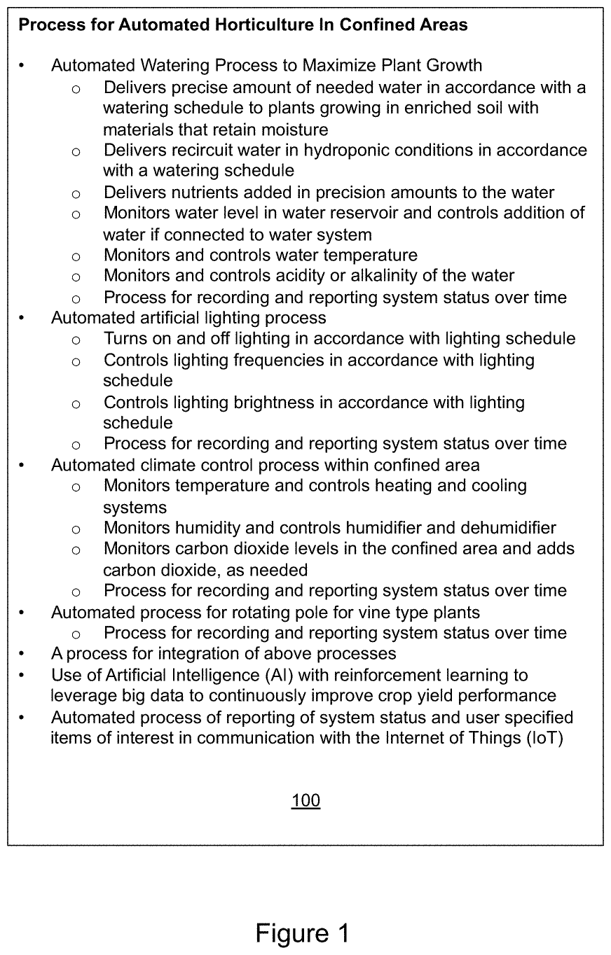

FIG. 1 illustrates a process for automated horticulture in confined areas. Text box 101 details key steps in automated growing of plants in constrained areas. These areas include but, are not limited to the following: kitchen, balcony, or other areas in urban or residential homes and apartments. It would require minimal time and effort on the part of the owner/user. And, importantly, the system would provide a source of fresh fruits and vegetables with minimal time from the horticultural system to the table. Key steps in the automated process include: individualized water delivery to each compartment; specialized lighting; climate control and status reporting. Of importance is the use of Artificial Intelligence (AI) with reinforcement learning to leverage big data to continuously improve crop yield performance. Further, the system can be integrated with the Internet of Things (IoT).

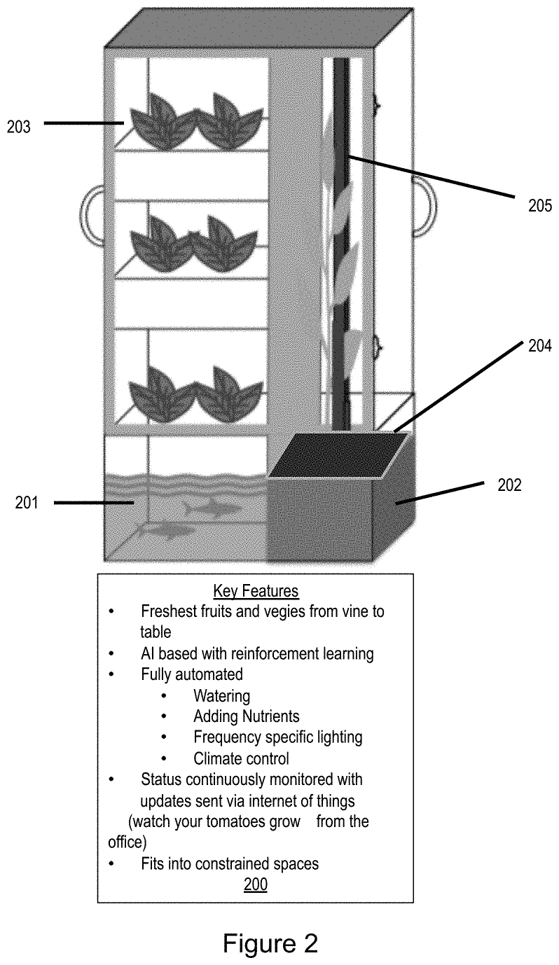

FIG. 2 illustrates a system illustration and description. Text box 200 illustrates key features. In addition, an example configuration which combines the capability to support hydroponic vegetable (e.g., lettuce) plant growth along with traditional soil fruits and vegetables is shown. The water reservoir 201 is shown. The soil container 202 is shown. The plant growth area with drawers 203 is shown. The tall plant growth area 204 is shown. A rotating pole system 205 enables vine type plants such as tomatoes or peas 205.

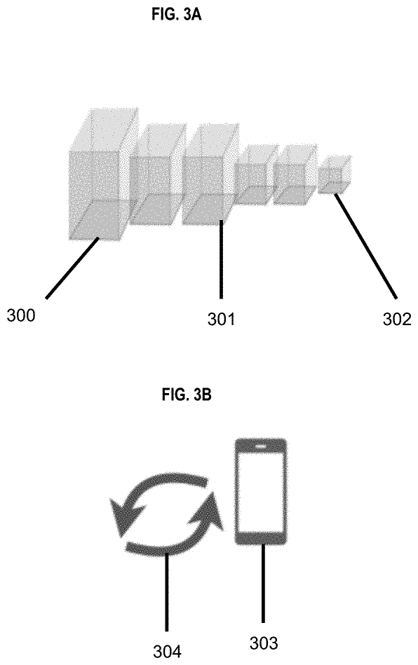

FIG. 3A illustrates varying sizes and configurations of the apparatus. 300 illustrates large size. 301 illustrates medium size. 302 illustrates small size. These different sizes and shapes allow the horticultural system to be configures to with a wide variety of confined areas.

FIG. 3B illustrates an example wireless phone can interact with the horticultural system. 303 illustrates the wireless phone. 304 illustrates the wireless communication link.

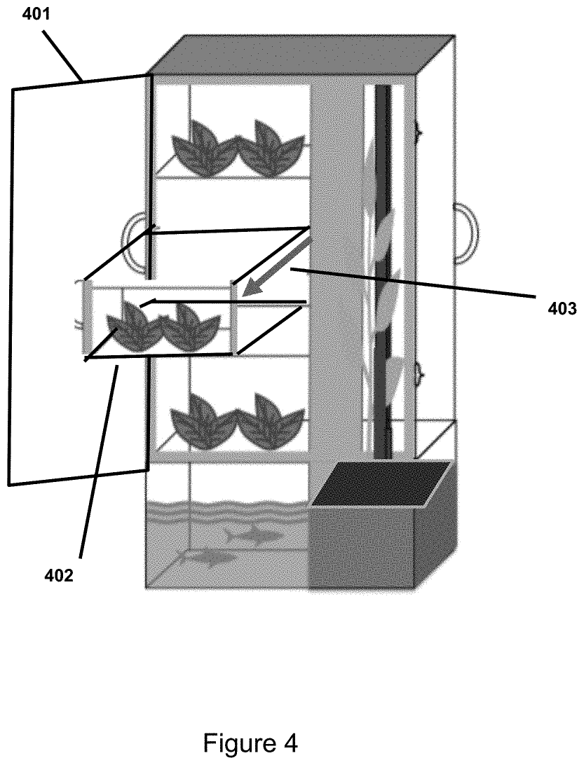

FIG. 4 example configuration with door open and plant tray protruding from structure for easy access by user. The example window type door is show is shown open 401. The retractable shelf has been pulled out 402 as illustrated by the arrow 403. This permits easy access to the grown plants as facilitates to planting process.

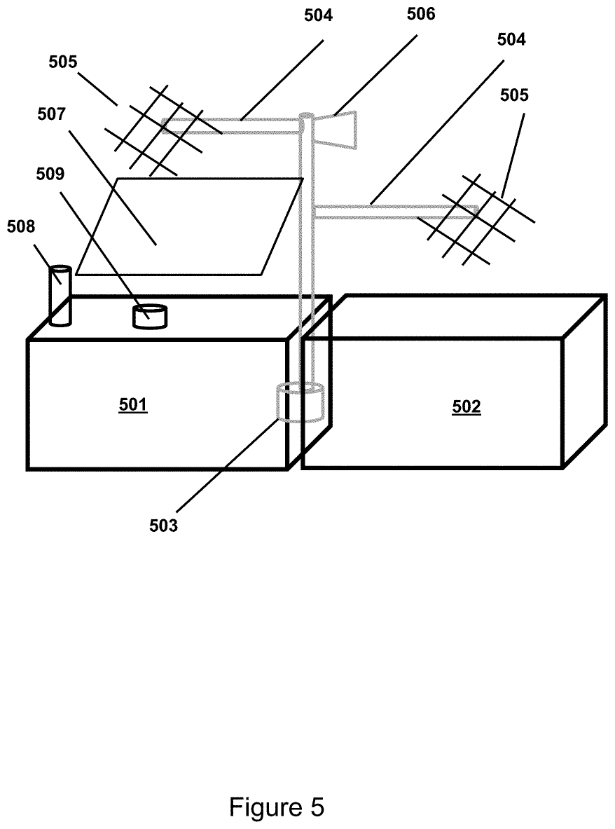

FIG. 5 illustrates an example water delivery system components. The objective of the water delivery system is to provide the optimal amount of water with the proper level of nutrients and the time and temperature to stimulate maximum plant growth. The first component 501 is the water reservoir. As shown in FIG. 2, this reservoir was associated with hydroponic water delivery but, would also serve as the source of water for traditional earth plantings. A reservoir would also be in the structure for soil 502. A water filter working in combination with a water pump would catch any foreign material and be positioned in front of the water pump 503. Next comes example plumbing 504. Per FIG. 2, the plumbing must accommodate both the traditional soil type watering as well as the hydroponic watering. For the soil type watering, the delivery could be a slow drip 505 in the vicinity of plant stems. For the hydroponic watering, delivery could include but, not be limiters to a drip grid 505 or a spray mist 506. The platform to support hydroponic plants is also shown 507. A dispenser for nutrient 508 is illustrated and, also, a sensor system to monitor the water temperature and acidity and alkalinity 509. Not illustrated but, also an important element is connection to the computer for status reporting.

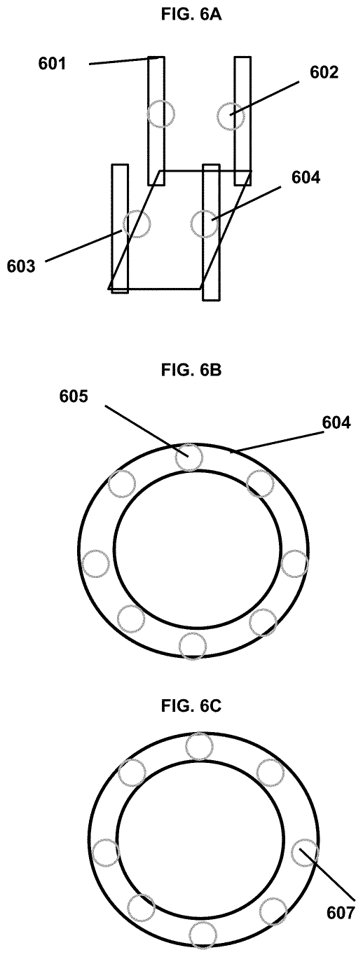

FIG. 6A illustrates a first example lighting system layout. The objective of the artificial lighting system is to provide optimal lighting duration of with the optimal frequency content of frequencies from the electro-magnetic spectrum at the correct brightness to stimulate maximum plant growth. For example, in early stages of plant growth, certain frequencies are optimal. Also, the brightness or intensity levels should be low. As the plant matures, the frequencies and intensity levels should change. Different plant types may need different frequencies. Several example light placements and lighting sequences and shown in this Figure. The placement of lights at four corners of the plant(s) compartment. The height of these lights could be arranged to provide near hemispherical lighting. 600 is a position of a first light. 601 is a position of a second light. 603 is a position of a third light. 604 is a position of a fourth light.

FIG. 6B shows a circular arrangement of lights at a first time point. 604 illustrates a circular frame. 605 illustrates a light, which is on at a first time point.

FIG. 6C shows a circular arrangement of lights at a second time point. The lighting sequence (one at a time) such that it could promote vine type plants to slowly encircle the pole. For example, 607 shows a different light turned on at a subsequent time point.

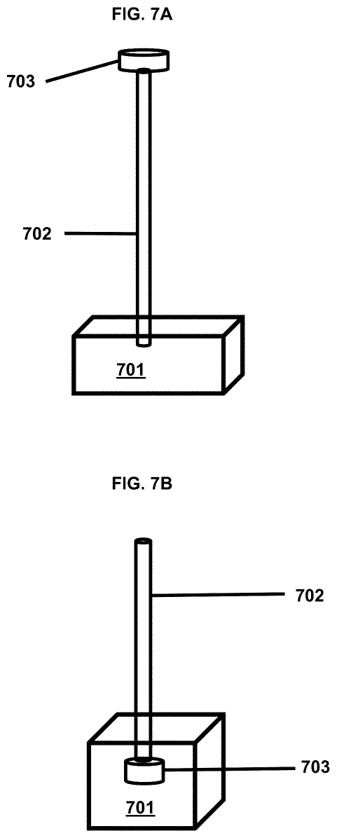

FIG. 7A illustrates a first example rotatable pole mounting configuration. In addition to a stationary pole, a automated rotatable pole 702 is a possible configuration. There are potential advantages of having an automated rotatable pole which include: the vertical distance between successive encirclements of a vine can be reduced through a combination rotation rate and timing of lighting sequence from FIG. 6A. This will have the effect of increasing the plant yield. A motor 703 mounted onto the top of the confined horticulture area 701 (e.g., where the soil is contained) is shown. The rotation rate of the pole and the sequence of lighting would be under the direction of the control system.

FIG. 7B illustrates a second example rotatable pole mounting configuration. 702 illustrates an automated rotatable pole. 703 illustrates the motor, which is located beneath the surface of the soil.

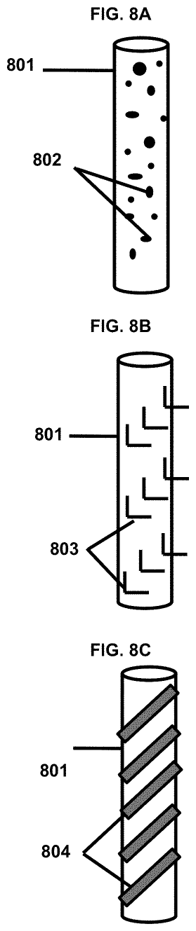

FIG. 8A illustrates a rotatable pole with textures. 801 illustrates the rotatable pole. Different textures 802 for the outer surface are possible. Several are illustrated in this figure. The purpose of the texture is to enable the vine to cling to the pole not only as it grows up the pole, but also as the vine produces fruits and vegetables. Examples include, but are not limited to the following: a rough surface such as, but not limited to: sandpaper; and, Velcro.

FIG. 8B illustrates small spikes or hooks which protrude from the outer surface of the pole. 801 illustrates the rotatable pole. 803 illustrates the hooks.

FIG. 8C illustrates a textures groove surface on the outside portion of the pole. 801 illustrates the rotatable pole. 804 illustrates the texture grooves.

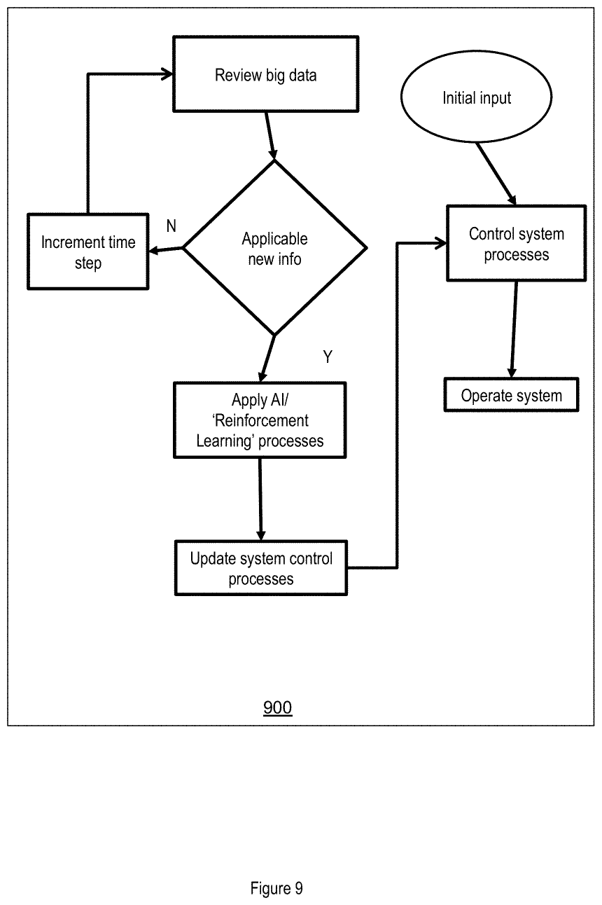

FIG. 9 illustrates bringing in artificial intelligence to optimize plant growth. 900 highlights how an already smart automated horticulture system can become ever increasingly smarter. This is accomplished through leveraging what is called in the world ‘Big Data’. For example, as new data becomes available on how different frequencies affect plant growth rates and increase fruit and vegetable yields, the reinforcement learning processes would leverage this new data and update system control processes. And, the automated horticulture system would then be operated under these new processes.

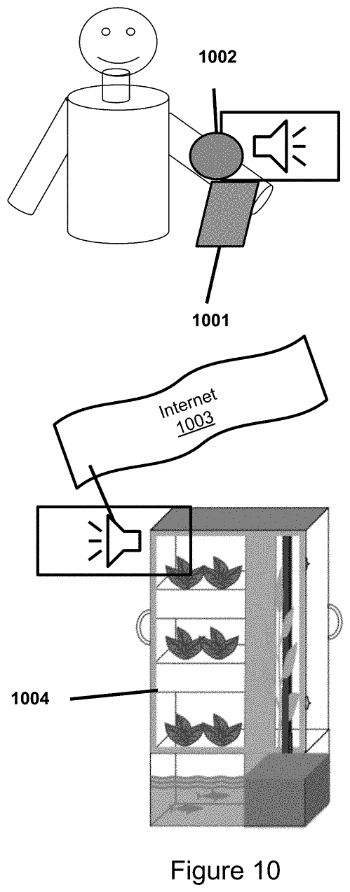

FIG. 10 illustrates an example interface with the internet of things. This figure illustrates how the user could interact with the system through the use of the internet. This alerts the user such things but, not limited to: system status; time to add more nutrients; when it is time to harvest; etc. The user is either carrying smart phone 1001 or wearing a smart watch 1002. These smart devices would be in communication with the automated horticulture system by wifi 1003 and, likewise, the automated horticulture 1004 system would be in communication with the smart devices by wifi 1003.

What is claimed is:

1. A method to provide automated horticulture for confined areas consisting of the following:
an automated watering process in accordance with a watering schedule;
an automated artificial lighting process in accordance with a lighting schedule;
an automated climate control process to maintain horticulture system in accordance with climate parameters; and
an automated process of recording and reporting of system status.

2. The method of claim 1 further comprising an automated process of adding nutrients to the water.

3. The method of claim 1 further comprising an automated process to control operation of a rotating pole.

4. The method of claim 1 further comprising monitoring at least one of the group of the pH of the water, the temperature of the water temperature, the temperature of the horticulture growing area, the humidity of the horticulture growing area, and the carbon dioxide in the horticulture growing area.

5. The method of claim 1 further comprising reporting process of system status and user specified items of interest in communication with the Internet of Things.

6. The method of claim 1 further comprising wherein the watering, lighting and climate control is designed to mimic a certain climate region of the world.

7. The method of claim 6 further comprising wherein the harvest is designed to mimic a certain region of the world.

8. An apparatus for provide automated horticulture comprising:
a frame;
at least one tray on which plants can grow;
an automated watering system to deliver water in accordance with a watering schedule;
an automated artificial lighting system to provide artificial lighting in accordance with a lighting schedule;
an automated climate control system to maintain system climate in accordance with climate parameters; and
a computer system for integration of above processes.

8. The apparatus of claim 8 further comprising at least one of the group of: a rotating pole, a camera system for monitoring plant status; an artificial intelligence system for optimizing plant growth; and, a wifi system in communication with the Internet of Things.

9. The apparatus of claim 8 further comprising wherein the watering system comprises at least one of the group of: water filter system; water pump system; plumbing system; water drip system; water mist system; nutrient insertion system; water temperature monitoring/heating and cooling system; acidity or alkalinity of the water monitoring and chemical insertion system; and, a recording system for water system status over time.

10. The apparatus of claim 8 further comprising wherein the lighting system comprises at least one of the group of: system that provides lighting which turn on and off lighting in accordance with lighting schedule; system that provides lighting of specified frequencies in accordance with lighting schedule; system that provides lighting of specified brightness in accordance with lighting schedule; a recording and reporting system for lighting system status over time.

11. The apparatus of claim 8 further comprising a climate control system consisting of at least one of the following: system to monitor temperature and heat/cool to maintain temperature in a pre-specified temperature range; system to monitor humidity and humidifier/de-humidifier to maintain humidity in a pre-specified humidity range; adding a carbon dioxide dispenser to dispense carbon dioxide, as needed; and, a recording and reporting system for climate control system status over time.

12. The apparatus of claim 8 further comprising wherein the apparatus is placed into an artificial gravity center to enable plant growth in micro-gravity environments.

13. A method comprising:
using a sensor system to collect data within a horticulture system;
analyzing the collected data with a mathematical model or artificial intelligence algorithm;
using the mathematical model or artificial intelligence algorithm to determine at least one intervention to maximize the yield of the horticulture system; and
inputting the at least one intervention into the horticulture system.

14. The method of claim 13 further comprising wherein using the collected data us used for at least one of the group of updating the training dataset with water data, nutrition level data, waste level data, air level data, and imagery data.

15. The method of claim 13 further comprising wherein the at least one intervention into the garden comprise at least one of the group comprising: adjusting light frequencies; providing recommendation of the spacing of the plants; providing instructions on the watering rates; and, providing instructions on the nutrition requirements.

16. The method of claim 13 further comprising wherein the training dataset is continuously updated.

17. The method of claim 13 further comprising wherein the yield determining at least one intervention to maximize the yield of the horticulture system.

18. The method of claim 13 further comprising wherein the mathematical model comprises at least one of the group comprising: linear regression; logistic regression; and, other statistical techniques.

19. The method of claim 13 further comprising wherein the artificial intelligence algorithm comprises at least one of the group of: neural network; deep learning; and other artificial intelligence processes.

20. The apparatus of claim 19 further comprising wherein the artificial intelligence system analyzes data from an artificial gravity device to maximize plant growth in micro-gravity environments.
